(19) United States
(12) Patent Application Publication
(10) Pub. No.: US 2024/0077115 A1
(43) Pub. Date: Mar. 7, 2024

(54) TEMPERATURE RISE VALUE ESTIMATING METHOD, THERMAL DISPLACEMENT AMOUNT ESTIMATING METHOD, AND BEARING COOLING APPARATUS CONTROL METHOD FOR MACHINE TOOL, AND MACHINE TOOL

(71) Applicant: OKUMA CORPORATION, Niwa-Gun (JP)

(72) Inventors: Misaki HIDA, Niwa-Gun (JP); Reiji KANBE, Niwa-Gun (JP)

(73) Assignee: OKUMA CORPORATION, Niwa-Gun (JP)

(21) Appl. No.: 18/458,295

(22) Filed: Aug. 30, 2023

(30) Foreign Application Priority Data
Sep. 7, 2022 (JP) 2022-142451

(51) Int. Cl. F16C 37/00; G01K 13/00

(52) U.S. Cl. CPC F16C 37/007; G01K 13/00; F16C 2233/00

(57) ABSTRACT

A temperature rise value estimating method for a machine tool including a cooling apparatus configured to cool a specific portion and a plurality of sensors. The temperature rise value estimating method includes: determining a cooling state of the specific portion by determining whether the cooling apparatus is in an operating state or a stopped state and determining whether a time measured from a base point of an activation or a stoppage of the cooling apparatus has elapsed a predetermined delay time or not; selecting an estimation model corresponding to the determined cooling state of the specific portion from a plurality of estimation models prepared in advance corresponding to different cooling states of the specific portion; and calculating an estimated temperature rise value of the specific portion based on the selected estimation model and temperature data derived from a measured value acquired by the plurality of temperature sensors.

### CROSS REFERENCE TO RELATED APPLICATION

This application claims the benefit of Japanese Patent Application Number 2022-142451 filed on Sep. 7, 2022, the entirety of which is incorporated by reference.

### FIELD OF THE INVENTION

The disclosure relates to a method for accurately estimating a temperature rise value of a heat-generating portion, a method for estimating a thermal displacement amount of the heat-generating portion, and a method for controlling a cooling apparatus for cooling the heat-generating portion of a machine tool, depending on a condition of the heat-generating portion in the machine tool including a cooling apparatus, and the machine tool capable of executing the method for estimating a temperature rise value.

### BACKGROUND OF THE INVENTION

In processing with a machine tool including a machining center, a rotation shaft, such as a spindle, generates heat due to friction between the rotation shaft and a bearing and causes an axial thermal displacement. The thermal displacement can be a factor in deteriorating its machining accuracy. Therefore, in order to avoid an occurrence of the thermal displacement, a method is generally employed in which a flow path is provided in a housing portion outside the bearing to flow cooling oil, and the heat of the cooling oil is removed by a cooling device.

However, power consumption of the cooling apparatus for the rotation shaft cooling device occupies a high proportion of those of peripheral devices of the machine tool. Therefore, from a carbon-neutral perspective, power consumption has been reduced by controlling operation of the cooling apparatus in order to reduce the power consumption. JP 6445395 B discloses a method of reducing power consumption by controlling operation of a cooling apparatus when a temperature close to a spindle calculated using a spindle temperature rise value satisfies a predetermined threshold while the spindle is stopped.

On the other hand, in order to suppress an influence of thermal displacement on machining accuracy, a method of estimating a thermal displacement amount from machine body temperature information and correcting a phase is used in some cases. For example, JP 1997-225781 A discloses a calculation method for estimating a spindle thermal displacement by changing a calculation coefficient of a thermal displacement estimation calculation formula according to rotation speed and time or the number of corrections.

In addition to heat generation if an abnormality in a bearing or an insufficient lubrication of the bearing occurs when a rotation shaft rotates, a failure such as a bearing seizure occurs in some cases. In order to avoid the failure, JP 6967495 B discloses a method of measuring a temperature difference between inner and outer races of a bearing with a heat flow sensor to detect a sudden temperature rise at a time of a bearing failure or lubrication.

With acceleration of energy-saving measures for realization of a decarbonized society, the reduction of power consumption by controlling operation of a spindle cooling apparatus should be performed not only when a machine is at rest as disclosed in JP 6445395 B but also while a machine is running. However, when an operation of the spindle cooling apparatus is controlled during machine operation, a thermal displacement property is different between when the spindle cooling apparatus is running and when it is stopped. Thus, the method disclosed in JP 1997-225781 A is not capable of accurately estimating the thermal displacement amount. Therefore, in order to accurately estimate a thermal displacement amount, it is necessary to use estimation models according to states of a heat-generating portion.

Meanwhile, if a cooling capacity during shaft rotation were reduced in order to suppress fluctuation in thermal displacement property, temperature of the bearing could rise and lead to a failure such as seizure. In addition, when the reduced cooling capacity is restored, the outer race side of the bearing is rapidly cooled to increase the temperature difference between the inner and outer races, thus possibly causing seizure. In view of this, it is necessary to measure the inner race temperature to control the operation of the cooling apparatus while monitoring the temperature difference between the inner and outer races during machine operation. However, the method for detecting the temperature difference between the inner and outer races disclosed in JP 6967495 B requires a heat flow sensor installed on a proximity of the bearing and is difficult to handle with a measurement unit. Accordingly, if use of the models according to the states of the bearing as a heat-generating portion allows accurately estimating a value corresponding to the bearing inner race temperature, it is considered to solve the problem of the difficulty in handling the measurement unit.

Therefore, a purpose of the disclosure provides a temperature rise value estimating method for a machine tool and a machine tool that can accurately estimate a temperature rise value generated in a heat-generating portion based on an estimation model selected according to a state of a cooling apparatus for cooling the heat-generating portion and the state of the heat-generating portion.

In addition, another purpose of the disclosure provides a thermal displacement amount estimating method for the machine tool that can accurately estimate a thermal displacement amount generated in the heat-generating portion using the temperature rise value of the heat-generating portion estimated based on the estimation model selected according to the state of the cooling apparatus for cooling the heat-generating portion and the state of the heat-generating portion, and temperature information of the machine body.

In addition, another purpose of the disclosure provides a bearing cooling apparatus control method capable of monitoring a temperature difference between inner and outer races of a bearing using the temperature rise value of the bearing estimated based on the estimation model selected according to a state of a bearing cooling apparatus and a state of the bearing cooling apparatus and the temperature information of the machine body, and capable of controlling operation of the bearing cooling apparatus during machine operation.

### SUMMARY OF THE INVENTION

In order to achieve the above-described object, there is provided a first configuration of the disclosure. A machine tool includes a cooling apparatus configured to cool a specific portion that generates heat due to operation of the machine tool and a plurality of sensors disposed at freely-selected positions including at least a position where a machine body temperature is measurable and a position where a temperature of the specific portion is measurable. The first configuration includes: determining a cooling state of the specific portion by determining whether the cooling apparatus is in an operating state or a stopped state and by determining whether a time measured from a base point of an activation or a stoppage of the cooling apparatus has elapsed a predetermined delay time or not; selecting an estimation model corresponding to the determined cooling state of the specific portion from a plurality of estimation models prepared in advance corresponding to different cooling states of the specific portion; and calculating an estimated temperature rise value of the specific portion based on the selected estimation model and temperature data derived from a measured value acquired by the plurality of temperature sensors.

Another aspect of the first configuration of the disclosure, which is in the above configuration, determines the cooling state of the specific portion as any one of at least four states including a temperature fall transient state from an activation of the cooling apparatus until the delay time elapses, a temperature rise transient state from a stoppage of the cooling apparatus until the delay time elapses, a cooling steady state after the delay time elapsed from the activation of the cooling apparatus, and a heating steady state after the delay time elapsed from the stoppage of the cooling apparatus.

In another aspect of the first configuration of the disclosure, which is in the above configuration, the delay time is calculated from a value obtained based on an operation of the specific portion using a predetermined function.

In another aspect of the first configuration of the disclosure, which is in the above configuration, the delay time is a time until an amount of change per time becomes larger than a predetermined threshold value, the amount of change per time being calculated for at least one of the temperature data and the estimated temperature rise value of the specific portion.

In order to achieve the above-described object, there is provided a second configuration of the disclosure. A machine tool includes a cooling apparatus configured to cool a specific portion that generates heat due to operation of the machine tool and a plurality of sensors disposed at freely-selected positions including at least a position where a machine body temperature is measurable and a position where a temperature of the specific portion is measurable. The second configuration includes: determining a cooling state of the specific portion by determining whether the cooling apparatus is in an operating state or a stopped state and by determining whether a time measured from a base point of an activation or a stoppage of the cooling apparatus has elapsed a predetermined delay time or not; selecting an estimation model corresponding to the determined cooling state of the specific portion from a plurality of estimation models prepared in advance corresponding to different cooling states of the specific portion; calculating an estimated temperature rise value of the specific portion based on the selected estimation model and temperature data derived from a measured value acquired by the plurality of temperature sensors; and estimating a thermal displacement amount of the specific portion using the calculated estimated temperature rise value of the specific portion and a coefficient for converting a temperature rise value of the specific portion into the thermal displacement amount, based on the selected estimation model.

Another aspect of the second configuration of the disclosure, which is in the above configuration, determines the cooling state of the specific portion as any one of at least four states including a temperature fall transient state from an activation of the cooling apparatus until the delay time elapses, a temperature rise transient state from a stoppage of the cooling apparatus until the delay time elapses, a cooling steady state after the delay time elapsed from the activation of the cooling apparatus, and a heating steady state after the delay time elapsed from the stoppage of the cooling apparatus.

In another aspect of the second configuration of the disclosure, which is in the above configuration, the delay time is calculated from a value obtained based on an operation of the specific portion using a predetermined function.

In another aspect of the second configuration of the disclosure, which is in the above configuration, the delay time is a time until an amount of change per time becomes larger than a predetermined threshold value, the amount of change per time being calculated for at least one of the temperature data and the estimated temperature rise value of the specific portion.

In order to achieve the above-described object, there is provided a third configuration of the disclosure. A machine tool includes a cooling apparatus having a path configured to cool an outer race side of a bearing for at least the rotation shaft and a plurality of sensors disposed at freely-selected positions including at least a position where a machine body temperature is measurable and a position where a temperature of the outer race side of a bearing. The bearing cooling apparatus control method includes: determining a cooling state of the bearing by determining whether the cooling apparatus is in an operating state or a stopped state and by determining whether a time measured from a base point of an activation or a stoppage of the cooling apparatus has elapsed a predetermined delay time or not; selecting an estimation model corresponding to the determined cooling state of the bearing from a plurality of estimation models prepared in advance corresponding to different cooling states of the bearing; calculating an estimated temperature rise value of an inner race side of the bearing using a coefficient based on the selected estimation model and temperature data derived from a measured value acquired by the plurality of temperature sensors; calculating an estimated inner and outer race temperature difference from the calculated estimated temperature rise value on the inner race side of the bearing and a temperature rise value of the outer race side of the bearing calculated based on the temperature data derived from the measured value acquired by the temperature sensor measuring a temperature of the outer race side of the bearing; and activating or stopping the cooling apparatus when the estimated inner and outer race temperature difference exceeds or falls below a predetermined threshold based on the selected estimation model.

Another aspect of the third configuration of the disclosure, which is in the above configuration, determines the cooling state of the bearing as any one of at least four states including a temperature fall transient state from an activation of the cooling apparatus until the delay time elapses, a temperature rise transient state from a stoppage of the cooling apparatus until the delay time elapses, a cooling steady state after the delay time elapsed from the activation of the cooling apparatus, and a heating steady state after the delay time elapsed from the stoppage of the cooling apparatus.

In another aspect of the third configuration of the disclosure, which is in the above configuration, the delay time is calculated from a rotation speed of the rotation shaft using a predetermined function.

In another aspect of the third configuration of the disclosure, which is in the above configuration, the delay time is a time until an amount of change per time becomes larger than a predetermined threshold value, the amount of change per time being calculated for at least one of the temperature data, the estimated temperature rise value of the inner race side of the bearing, and the estimated inner and outer race temperature difference.

In order to achieve the above-described object, there is provided a fourth configuration of the disclosure. A machine tool includes a cooling apparatus, a plurality of sensors, and a device. The cooling apparatus is configured to cool a specific portion that generates heat due to operation of the machine tool. The plurality of sensors are disposed at freely-selected positions including at least a position where a machine body temperature is measurable and a position where a temperature of the specific portion is measurable. The device is configured to: determine a cooling state of the specific portion by determining whether the cooling apparatus is in an operating state or a stopped state and by determining whether a time measured from a base point of an activation or a stoppage of the cooling apparatus has elapsed a predetermined delay time or not; select an estimation model corresponding to the determined cooling state of the specific portion from a plurality of estimation models prepared in advance corresponding to different cooling states of the specific portion; and calculate an estimated temperature rise value of the specific portion based on the selected estimation model and temperature data derived from a measured value acquired by the plurality of temperature sensors.

Another aspect of the fourth configuration of the disclosure, which is in the above configuration, determines the cooling state of the specific portion as any one of at least four states including a temperature fall transient state from an activation of the cooling apparatus until the delay time elapses, a temperature rise transient state from a stoppage of the cooling apparatus until the delay time elapses, a cooling steady state after the delay time elapsed from the activation of the cooling apparatus, and a heating steady state after the delay time elapsed from the stoppage of the cooling apparatus.

According to the first and the fourth configurations of the disclosure, when estimating the temperature rise value that occurs in the specific portion as a cooling target due to the activation or the stoppage of the cooling apparatus during machine operation, selecting the estimation model corresponding the cooling state of the portion changing caused by the operation or the stoppage of the cooling apparatus allows the accurate estimation of the temperature rise value of the specific portion.

According to the second configuration of the disclosure, when estimating the thermal displacement amount that occurs in the specific portion as the cooling target due to the activation or the stoppage of the cooling apparatus during machine operation, selecting the estimation model corresponding the cooling state of the portion changing caused by the operation or the stoppage of the cooling apparatus allows the accurate estimation of the thermal displacement amount of the specific portion. Therefore, even when the cooling apparatus is activated or stopped during machine operation, it is possible to accurately compensate for the thermal displacement occurring in the portion to allow suppressing deterioration of the machining accuracy.

According to the third configuration of the disclosure, when estimating the inner and outer race temperature difference that occurs in the bearing as the cooling target due to the activation or the stoppage of the cooling apparatus during machine operation, selecting the estimation model corresponding the cooling state of the bearing changing caused by the operation or the stoppage of the cooling apparatus allows the accurate estimation of the estimated inner and outer race temperature difference having occurred in the bearing. Therefore, the cooling apparatus can be controlled according to the estimated inner and outer race temperature difference. Since the temperature of the bearing during operation can be stabilized, it is possible to reduce problems such as seizure of the bearing.

### BRIEF DESCRIPTION OF THE DRAWINGS

FIG. 1 is an explanatory diagram illustrating a main part of a machine tool of an embodiment 1.

FIG. 2 is a flow chart illustrating an estimating method of a thermal displacement amount of the disclosure.

FIG. 3 is an explanatory diagram illustrating a main part of a machine tool of an embodiment 2.

FIG. 4 a flow chart illustrating a controlling method of a cooling apparatus of the disclosure.

### DETAILED DESCRIPTION OF THE INVENTION

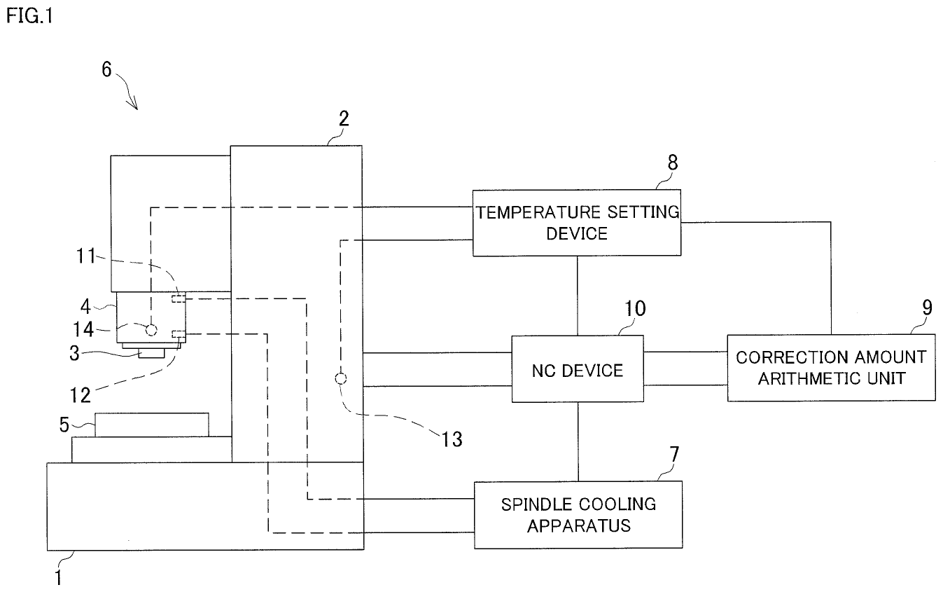

The following describes embodiments of the disclosure based on the drawings. FIG. 1 is an explanatory diagram illustrating a main part of a machine tool of an embodiment 1. Note that a machine tool shown in FIG. 1 omits a cover and other equipment, and in practice, it is provided with a cover and other equipment not shown.

As illustrated in FIG. 1, the machine tool of the embodiment 1 includes a machining center 6 provided with a bed 1, a column 2, a spindle 3, a spindle unit 4 with a bearing, and a table 5. The machine tool of the embodiment 1 also includes a spindle cooling apparatus 7, a temperature setting device 8, a correction amount arithmetic unit 9, and an NC device 10. The spindle unit 4 has a spindle housing outer cylinder provided with a cooling oil supply unit 11 and a cooling oil discharge unit 12. A cooling circuit disposed between the machining center 6 and the spindle cooling apparatus 7 supplies a cooling oil to a cooling oil supply unit 11 and returns it from the cooling oil discharge unit 12 to the spindle cooling apparatus 7. That is, in the embodiment 1, the spindle unit 4 is a specific portion that generates heat by an operation of the machine tool and is a cooling target during machine operation in the disclosure. The NC device 10 includes a central processing unit (CPU) and a memory connected to the CPU and ensures the operations.

The machining center 6 includes a temperature sensor 13, which is disposed in the column 2 and detects a machine body temperature as a reference temperature, and a temperature sensor 14, which is disposed in the spindle unit 4 and detects a spindle temperature. The temperature sensors 13, 14 are connected to the temperature setting device 8, and measured temperature values measured by the temperature sensors 13, 14 are transmitted to the temperature setting device 8.

The NC device 10 is connected to the machining center 6, and the machining center 6 is operated under control by receiving commands from the NC device 10. In addition, the NC device 10 is connected to the spindle cooling apparatus 7, the temperature setting device 8, which is capable of executing a digitalization process and the like of the acquired measured temperature values from the temperature sensors 13, 14, and the correction amount arithmetic unit 9 described later, which calculates a correction amount from an estimated amount of the thermal displacement. The NC device 10 controls them.

The spindle cooling apparatus 7 is configured such that when a difference between the machine body temperature detected by the temperature sensor 13 when the spindle is operated at the maximum rotational speed and the spindle temperature detected by the temperature sensor 14, during machine operation of the machine tool exceeds or falls below threshold values, the spindle cooling apparatus 7 is switched between the operation and the stoppage.

Subsequently, a description will be given of an estimating method for a thermal displacement amount of the disclosure.

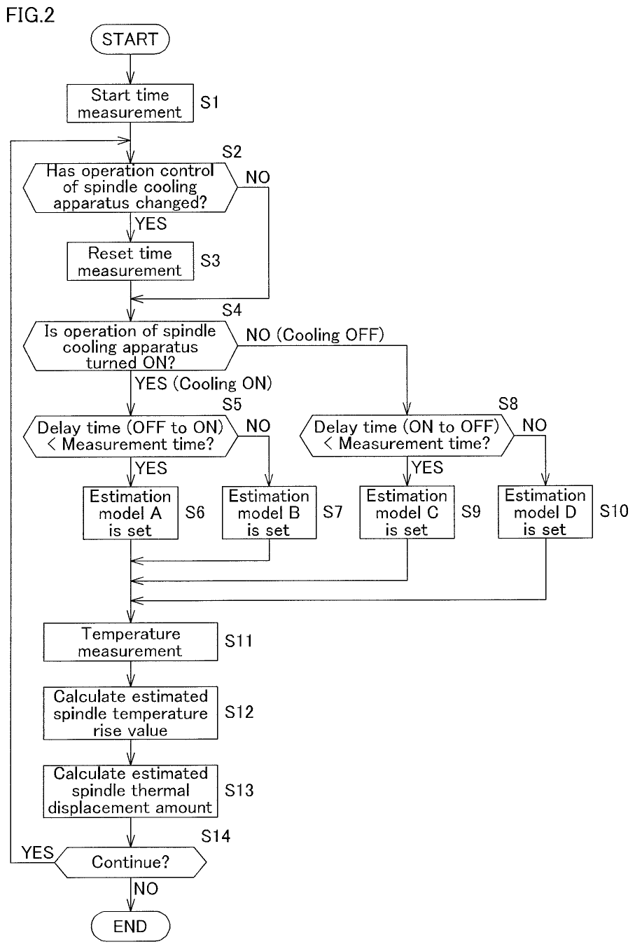

FIG. 2 is a flow chart illustrating an estimating method of a thermal displacement amount of the disclosure.

The NC device 10 measures a time from a base point at which the spindle cooling apparatus 7 is activated or stopped during machine operation of the machine tool (S1). In the time measurement, when it is determined that the operation control of the spindle cooling apparatus 7, such as activation and stop, has changed (S2), the time measured so far is reset (S3). After that, the time measurement is restarted from a base point at which the measurement time is reset, that is, the timing at which the spindle cooling apparatus 7 is switched between the operation and the stoppage. It should be noted that the determination, the calculations, and the like performed in the following description are performed by the NC device 10 unless otherwise specified.

Next, it is determined whether the spindle cooling apparatus 7 is operating or not at the time of executing the thermal displacement amount estimation (S4).

When the spindle cooling apparatus 7 is determined to be operating, the measurement time up to the time when the thermal displacement amount estimation is executed is compared with a predetermined delay time (S5).

As a result of comparing the measurement time and the delay time, when the measurement time is longer than the delay time, a cooling state of the spindle unit 4 is determined to be a cooling steady state after the delay time or more has elapsed since the spindle cooling apparatus 7 was activated. Then, an estimation model A, which is prepared in advance so as to correspond to the cooling steady state, is set as an estimation model used for the thermal displacement amount estimation (S6). When the measurement time is shorter than the delay time, the cooling state of the spindle unit 4 is determined to be a temperature fall transient state from when the spindle cooling apparatus 7 is activated until the delay time elapses. Then, an estimation model B, which is prepared in advance so as to correspond to the temperature fall transient state as the estimation model, is set (S7).

On the other hand, even when the spindle cooling apparatus 7 is determined to be stopped in S4, the measurement time up to the time when the thermal displacement amount estimation is executed is compared with a predetermined delay time (S8).

As a result of comparison between the measurement time and the delay time, when the measurement time is longer than the delay time, the cooling state of the spindle unit 4 is determined to be a heating steady state after the delay time or more has elapsed since the spindle cooling apparatus 7 was stopped. Then, an estimation model C, which is prepared in advance so as to correspond to the heating steady state as the estimation model, is set (S9). When the measurement time is shorter than the delay time, the cooling state of the spindle unit 4 is determined to be a temperature rise transient state from when the spindle cooling apparatus 7 is stopped until the delay time elapses. Then, an estimation model D, which is prepared in advance so as to correspond to the temperature rise transient state as the estimation model, is set (S10).

The delay times used in S5 and S8 are decided as times obtained by measuring a time from when the spindle cooling apparatus 7 is activated or stopped until the spindle unit 4 is cooled to a desired temperature and stabilized at the temperature or a time for the temperature to rise from the cooling state and stabilize at a constant temperature, experimentally in advance.

The estimation models A, B, C, and D include coefficients, functions, and the like used for estimating temperature rise values, thermal displacement amounts, and the like of the specific portion, which will be described later. The coefficient, the function, and the like of each of the estimation models A, B, C, and D are determined based on what has been experimentally derived in advance such that the temperature rise value and the thermal displacement amount of the spindle unit 4 correspond to the cooling state of the spindle unit 4.

After the selection of an estimation model corresponding to the cooling state of the spindle unit 4 in S6 to S7 and S9 to S10, the machine body temperature and the spindle temperature are measured by the temperature sensors 13, 14 (S11). The measured temperatures are collected by the temperature setting device 8, converted from analog signals to digital signals and quantified by a known method according to a predetermined cycle.

The temperature setting device 8 calculates an estimated spindle temperature rise value using numerical temperature data and Formula 1 (S12). Formula 1 includes a function for equalizing time responses of the temperature and the thermal displacement, which is set in advance for each of the estimation models. The calculated estimated spindle temperature rise value is transmitted to the correction amount arithmetic unit 9.

$${T}_{E S T n} = {T}_{E S T n - 1} + [ \{ {ΔT}_{M E S n} - d \times exp ( - \frac{t}{{τ}_{T E M P}} ) \} - {T}_{E S T n -} ] \times f ( t , {τ}_{i D E F} ) \qquad [ Formula 1 ]$$

n: Number of processes

T_{ESTn}: Estimated spindle temperature rise value

ΔT_{MESn}: Temperature rise value of spindle temperature based on machine body temperature d: Step difference (=rotation speed, or temperature rise value when cooling device control changes−previous estimation temperature) t: Rotation speed, or Time from when operation of spindle cooling apparatus changes τ_{TEMP}=Temperature time constant ƒ(t, τ_{iDEF}): Filter function (=t/(t+τ_{iDEF})) τ_{iDEF}: Thermal displacement time constant set in advance according to cooling state of spindle unit i: Cooling state of spindle unit

“i=1” indicates the state after the operating state of the spindle cooling apparatus is switched to the operation and the predetermined delay time has elapsed, that is, the estimation model A of the cooling steady state. “i=2” indicates the state from when the operating state of the spindle cooling apparatus is switched to the operation until the predetermined delay time elapses, that is, the estimation model B of the temperature fall transient state. “i=3” indicates the state after the operating state of the spindle cooling apparatus is switched to the stop and the predetermined delay time has elapsed, that is, the estimation model C of the heating steady state. “i=4” indicates the state from when the operating state of the spindle cooling apparatus is switched to the stop until the predetermined delay time elapses, that is, the estimation model D of the temperature rise transient state.

Subsequently, the correction amount arithmetic unit 9 calculates an estimated spindle thermal displacement amount using the estimated spindle temperature rise value calculated by the temperature setting device 8 and Formula 2 (S13). Formula 2 includes a conversion coefficient from the spindle temperature rise value to the spindle thermal displacement amount predetermined in advance for each of the estimation models.

[Formula 2]

Zₙ=Zₙ₋+(T_{ESTn}−T_{ESTn-1})×γᵢ

Zₙ: Estimated spindle thermal displacement

γᵢ: Predetermined temperature change conversion coefficient according to cooling state of spindle unit

Then, the correction amount arithmetic unit 9 calculates a correction amount necessary for maintaining a machining accuracy from the estimated spindle thermal displacement amount calculated in S13. The calculated correction amount is transmitted to the NC device 10 and fed back to the operation of the machining center 6.

Subsequently, it is determined whether or not to continue estimating the thermal displacement amount (S14), and when it is determined to be continued, the process restarts from S2, namely, the step of determining the change in the operation control of the spindle cooling apparatus 7.

As described above, when estimating the thermal displacement amount that occurs in the spindle 3 due to the activation or the stoppage of the spindle cooling apparatus 7 during operation of the machining center 6. selecting the estimation model corresponding to the cooling state of the spindle unit 4 that changes caused by the activation or the stoppage of the spindle cooling apparatus 7 allows accurately estimating the thermal displacement amount that occurs in the spindle 3. Therefore, even when the spindle cooling apparatus 7 is activated or stopped while the machining center 6 is in operation, it is possible to accurately correct the thermal displacement amount occurring in the spindle 3 so as to allow suppressing deterioration of the machining accuracy.

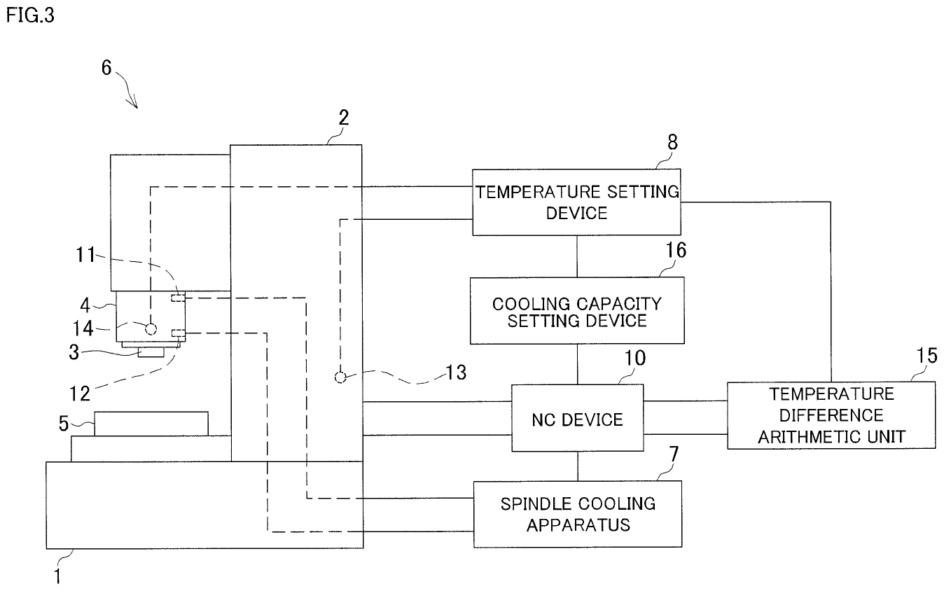

FIG. 3 is an explanatory diagram illustrating a main part of a machine tool of an embodiment 2.

As illustrated in FIG. 3, the machine tool of the embodiment 2 includes the bed 1, the column 2, the spindle 3 as the rotation shaft, the spindle unit 4 with the bearing, the machining center 6 provided with the table 5, the spindle cooling apparatus 7, the temperature setting device 8, a temperature difference arithmetic unit 15, a cooling capacity setting device 16, and the NC device 10. The spindle unit 4 has the spindle housing outer cylinder provided with the cooling oil supply unit 11 and the cooling oil discharge unit 12. The cooling circuit disposed between the machining center 6 and the spindle cooling apparatus 7 supplies a cooling oil to the cooling oil supply unit 11 and returns it from the cooling oil discharge unit 12 to the spindle cooling apparatus 7. That is, in the embodiment 2, the spindle unit 4 is the specific portion that generates heat by the operation of the machine tool and is a cooling target during machine operation in the disclosure. The NC device 10 includes a central processing unit (CPU) and a memory connected to the CPU and ensures the operations.

The machining center 6 includes the temperature sensor 13, which is disposed in the column 2 and detects a machine body temperature as a reference temperature, and the temperature sensor 14, which is disposed in the spindle unit 4 and detects the spindle temperature. The temperature sensors 13, 14 are connected to the temperature setting device 8, and the measured temperature values measured by the temperature sensors 13, 14 are transmitted to the temperature setting device 8.

The NC device 10 is connected to the machining center 6, and the machining center 6 is operated under control by receiving commands from the NC device 10. In addition, the NC device 10 is connected to the spindle cooling apparatus 7, the temperature setting device 8, which is capable of executing a digitalization process and the like of the acquired measured temperature values from the temperature sensors 13, 14, a temperature difference arithmetic unit 15, which calculates an estimated amount of an inner and outer race temperature difference of the spindle unit 4 from the estimated value of the temperature rise of the main spindle described later, and a cooling capacity setting device 16, which sets a cooling capacity of the spindle cooling apparatus 7. The NC device 10 controls them.

Subsequently, a description will be given of a controlling method of a cooling apparatus of the disclosure.

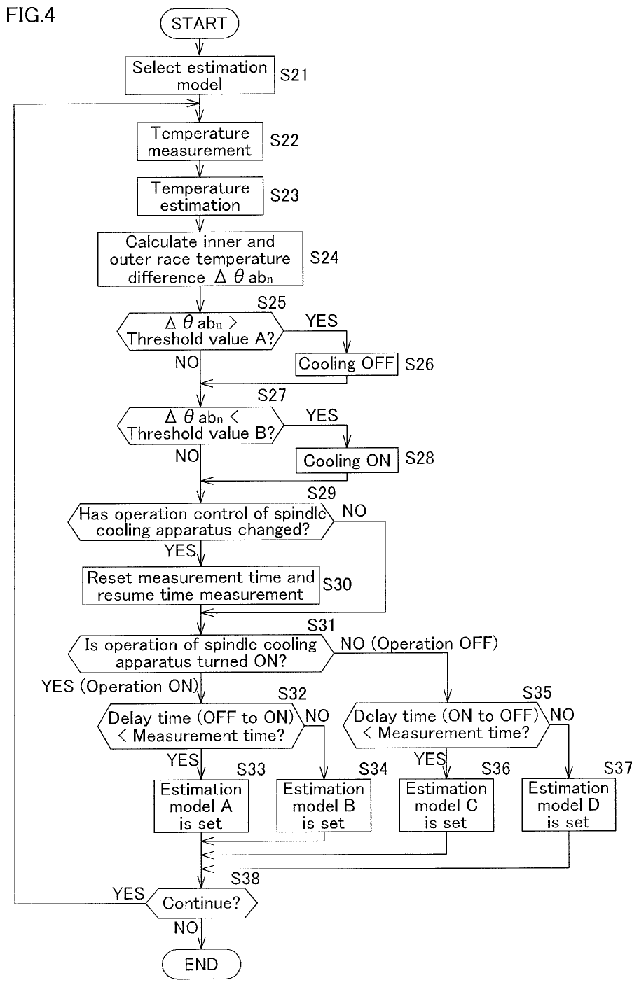

FIG. 4 a flow chart illustrating a controlling method of a cooling apparatus of the disclosure. The flow chart of FIG. 4 assumes that the spindle cooling apparatus 7 is in the operating state while the cooling state of the spindle unit 4 is in the cooling steady state, as an initial setting.

In the embodiment 2, first, the estimation model is selected (S21). The selection of the estimation model is executed in accordance with S2 to S10 shown in FIG. 2. As described above, the estimation model A is selected here because the cooling state of the spindle unit 4 is the cooling steady state.

After the estimation model is selected in S21, the temperatures of respective portions are measured by the temperature sensors 13, 14 (S22). The measured temperatures are collected by the temperature setting device 8, converted from analog signals to digital signals and quantified by a known method according to a predetermined cycle.

The temperature setting device 8 calculates an outer race side temperature rise value Δθbₙ, that is, a difference between a machine body temperature θ1ₙ and an outer race side temperature θ2ₙ from the digitized temperature data (Formula 3). Subsequently, the estimated inner race side temperature rise value Δθaₙ is calculated using Formula 4 and Formula 5 (S23). Formula 4 includes a coefficient a regarding a time response predetermined for each estimation model and Formula 5 includes a coefficient β regarding an amount of change. Note that the coefficients α and β set for each of the estimation models are determined in advance by experiments or the like. The calculated estimated inner ring side temperature rise value Δθaₙ is transmitted to the temperature difference arithmetic unit 15.

[Formula 3]

Δθbₙ=θ1ₙ−θ2ₙ

[Formula 4]

Δθₙ=Δθ1ₙ−θ1ₙ₋₁+(Δθbₙ−Δθbₙ₋₁)×(t/t+α)

[Formula 5]

Δθaₙ=Δθₙ×β

t: Rotation speed, or Time from when operation of spindle cooling apparatus changes

n: Number of processes

The temperature difference arithmetic unit 15 calculates an estimated inner and outer race temperature difference Δθabₙ from a difference between the outer race side temperature rise value Δθbₙ calculated by the temperature setting device 8 and the estimated inner race side temperature rise value Δθaₙ (S24).

The calculated estimated inner and outer race temperature difference Δθbₙ is compared with a predetermined threshold value A for cooling OFF determination (S25). When the estimated inner and outer race temperature difference Δθabₙ exceeds the threshold value A, the cooling state of the spindle unit 4 can be said that the spindle temperature has reached a desired temperature and no further cooling is required. Therefore, the cooling capacity setting device 16 issues a command to the spindle cooling apparatus 7 via the NC device 10 to stop or to operate with a cooling capacity capable of maintaining the spindle unit 4 at a desired temperature (S26).

On the other hand, when the estimated inner and outer race temperature difference Δθabₙ falls below the threshold value A, the estimated inner and outer race temperature difference Δθabₙ is subsequently compared with the predetermined threshold value B for cooling ON determination (S27). When the estimated inner and outer race temperature difference Δθabₙ falls below the threshold value B for cooling ON determination, the cooling state of the spindle unit 4 can be said that the spindle temperature has not reached the desired temperature and further cooling is required. Therefore, the cooling capacity setting device 16 issues a command to the spindle cooling apparatus 7 via the NC device 10 to operate with a cooling capacity capable of cooling the spindle unit 4 to a desired temperature, such as increasing the cooling capacity. (S28).

Next, it is determined whether or not there has been a change in the operation control of the spindle cooling apparatus 7 compared with the state at the time of the previous processing (S29). When it is determined that the operation control of the spindle cooling apparatus 7 has changed, the time measured so far is reset, and a time measurement is restarted with the timing as the base point at which the measurement time was reset (S30).

Subsequently, it is determined whether the spindle cooling apparatus 7 is operating or not (S31).

When it is determined that the spindle cooling apparatus 7 is operating, the time measured so far is compared with the predetermined delay time (S32).

As a result of comparing the measurement time and the delay time, when the measurement time is longer than the delay time, the cooling state of the spindle unit 4 is determined to be a cooling steady state after the delay time or longer has elapsed since the spindle cooling apparatus 7 was activated. Then, as an estimation model, the estimation model A set to correspond to the cooling steady state is set (S33). When the measurement time is shorter than the delay time, the cooling state of the spindle unit 4 is determined to be the temperature fall transient state from when the spindle cooling apparatus 7 is activated until the delay time elapses. Then, the estimation model B, which is prepared in advance so as to correspond to the temperature fall transient state as the estimation model, is set (S34).

On the other hand, even when the spindle cooling apparatus 7 is determined to be stopped in S31, the time measured so far is compared with the predetermined delay time (S35).

As a result of comparing the measurement time and the delay time, when the measurement time is longer than the delay time, the cooling state of the spindle unit 4 is determined to be the heating steady state after the delay time or longer has elapsed since the spindle cooling apparatus 7 was stopped. Then, the estimation model C, which is prepared in advance so as to correspond to the heating steady state as the estimation model, is set (S36). When the measurement time is shorter than the delay time, the cooling state of the spindle unit 4 is determined to be the temperature rise transient state from when the spindle cooling apparatus 7 is stopped until the delay time elapses. Then, the estimation model D, which is prepared in advance so as to correspond to the temperature rise transient state as the estimation model, is set (S37).

After the estimation model is set, it is determined whether or not to continue the operation control of the spindle cooling apparatus (S38), and when it is determined to be continued, the process restarts from S22, namely, the step of measuring the temperature by the temperature sensors 13, 14.

The above-described processes are performed at predetermined time intervals t.

When estimating the inner and outer race temperature difference Δθabₙ that occurs in the spindle unit 4 as the cooling target due to the operation or the stoppage of the spindle cooling apparatus 7 while the machining center 6 is running, selecting the estimation model corresponding the cooling state of the spindle unit 4 changing caused by the operation or the stoppage of the spindle cooling apparatus 7 allows the accurate estimation of the estimated inner and outer race temperature difference Δθabₙ having occurred in the spindle unit 4. Therefore, the spindle cooling apparatus 7 can be controlled according to the estimated inner and outer race temperature difference Δθabₙ. Since the temperature of the spindle unit 4 during operation can be stabilized, it is possible to reduce problems such as seizure of the spindle unit 4.

The disclosure has been described above based on the illustrated examples, and the technical scope thereof is not limited thereto. For example, as the specific portion to be targeted for any one of estimating the temperature rise, performing the thermal displacement correction, and controlling the cooling apparatus that cools the portion, in addition to the spindle unit and the spindle, any portion where at least one of any correction of the thermal displacement and any cooling are required since heat is generated by the machine operation, such as an another rotation shaft, a column, may be set.

Also, the temperature setting device, the correction amount arithmetic unit, the temperature difference arithmetic device, and the cooling capacity setting device may be provided separately, or may exist as a part of the functions of the NC device.

Also, the coefficients and the functions included in the estimation model can be freely-selected from those that can calculate the estimated temperature rise value of the specific portion from appropriate temperature data according to the type and the cooling state of the specific portion. As for the calculation of the estimated temperature rise value, any calculation method can be selected as long as an accurate temperature rise value of the specific portion can be estimated from the acquired temperature data.

Also, the delay time used when selecting the estimation model may be calculated and determined by calculation instead of being determined by experiments or the like. For example, the delay time used when selecting the estimation model associated with the rotation shaft may be calculated from the rotation speed of the rotation shaft using any function, such as those are expressed as T=P+QN where T is the delay time, N is the shaft rotation speed, and P and Q are the coefficients. Furthermore, the delay time may be the time until the absolute value |θbₙ−Δθbₙ₋₁| of the difference from the previous processing of the outer race side temperature rise value Δθbₙ becomes larger than a threshold determined in advance by experiments or the like. Furthermore, instead of the outer race side temperature rise value, by calculating the absolute value of the difference from the previous processing for the estimated temperature rise value of the inner race side, or the estimated inner and outer race temperature difference, the delay time may be set to the time until the calculated absolute value becomes larger than a threshold.

Also, the determination of what kind of command the cooling capacity setting device issues to the cooling apparatus may be determined by comparing the outer race side temperature rise value and a predetermined threshold value in addition to comparing the estimated inner and outer race temperature difference with the threshold. Furthermore, for example, a temperature sensor may be provided near a motor of the spindle to measure a motor temperature, and the determination may be made by comparing the motor temperature rise Δθc with a predetermined threshold value. Furthermore, the determination may be made by combining a plurality of the comparison results.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention. in particular as limits of value ranges.

1. A temperature rise value estimating method for a machine tool, wherein the machine tool includes a cooling apparatus configured to cool a specific portion that generates heat due to operation of the machine tool and a plurality of sensors disposed at freely-selected positions including at least a position where a machine body temperature is measurable and a position where a temperature of the specific portion is measurable, and
the temperature rise value estimating method comprises:
determining a cooling state of the specific portion by determining whether the cooling apparatus is in an operating state or a stopped state and by determining whether a time measured from a base point of an activation or a stoppage of the cooling apparatus has elapsed a predetermined delay time or not;
selecting an estimation model corresponding to the determined cooling state of the specific portion from a plurality of estimation models prepared in advance corresponding to different cooling states of the specific portion; and
calculating an estimated temperature rise value of the specific portion based on the selected estimation model and temperature data derived from a measured value acquired by the plurality of temperature sensors.

2. The temperature rise value estimating method for the machine tool according to claim 1, wherein
the temperature rise value estimating method determines the cooling state of the specific portion as any one of at least four states including a temperature fall transient state from an activation of the cooling apparatus until the delay time elapses, a temperature rise transient state from a stoppage of the cooling apparatus until the delay time elapses, a cooling steady state after the delay time elapsed from the activation of the cooling apparatus, and a heating steady state after the delay time elapsed from the stoppage of the cooling apparatus.

3. The temperature rise value estimating method for the machine tool according to claim 1, wherein
the delay time is calculated from a value obtained based on an operation of the specific portion using a predetermined function.

4. The temperature rise value estimating method for the machine tool according to claim 1, wherein
the delay time is a time until an amount of change per time becomes larger than a predetermined threshold value, the amount of change per time being calculated for at least one of the temperature data and the estimated temperature rise value of the specific portion.

5. A thermal displacement amount estimating method for a machine tool, wherein
the machine tool includes a cooling apparatus configured to cool a specific portion that generates heat due to operation of the machine tool and a plurality of sensors disposed at freely-selected positions including at least a position where a machine body temperature is measurable and a position where a temperature of the specific portion is measurable, and
the thermal displacement amount estimating method comprises:
determining a cooling state of the specific portion by determining whether the cooling apparatus is in an operating state or a stopped state and by determining whether a time measured from a base point of an activation or a stoppage of the cooling apparatus has elapsed a predetermined delay time or not;
selecting an estimation model corresponding to the determined cooling state of the specific portion from a plurality of estimation models prepared in advance corresponding to different cooling states of the specific portion;
calculating an estimated temperature rise value of the specific portion based on the selected estimation model and temperature data derived from a measured value acquired by the plurality of temperature sensors; and
estimating a thermal displacement amount of the specific portion using the calculated estimated temperature rise value of the specific portion and a coefficient for converting a temperature rise value of the specific portion into the thermal displacement amount, based on the selected estimation model.

6. The thermal displacement amount estimating method for the machine tool according to claim 5, wherein
the thermal displacement amount estimating method determines the cooling state of the specific portion as any one of at least four states including a temperature fall transient state from an activation of the cooling apparatus until the delay time elapses, a temperature rise transient state from a stoppage of the cooling apparatus until the delay time elapses, a cooling steady state after the delay time elapsed from the activation of the cooling apparatus, and a heating steady state after the delay time elapsed from the stoppage of the cooling apparatus.

7. The thermal displacement amount estimating method for the machine tool according to claim 5, wherein
the delay time is calculated from a value obtained based on an operation of the specific portion using a predetermined function.

8. The thermal displacement amount estimating method for the machine tool according to claim 5, wherein
the delay time is a time until an amount of change per time becomes larger than a predetermined threshold value, the amount of change per time being calculated for at least one of the temperature data and the estimated temperature rise value of the specific portion.

9. A bearing cooling apparatus control method for a machine tool including a rotation shaft, wherein
the machine tool includes a cooling apparatus having a path configured to cool an outer race side of a bearing for at least the rotation shaft and a plurality of sensors disposed at freely-selected positions including at least a position where a machine body temperature is measurable and a position where a temperature of the outer race side of a bearing, and
the bearing cooling apparatus control method comprises:
determining a cooling state of the bearing by determining whether the cooling apparatus is in an operating state or a stopped state and by determining whether a time measured from a base point of an activation or a stoppage of the cooling apparatus has elapsed a predetermined delay time or not;
selecting an estimation model corresponding to the determined cooling state of the bearing from a plurality of estimation models prepared in advance corresponding to different cooling states of the bearing;
calculating an estimated temperature rise value of an inner race side of the bearing using a coefficient based on the selected estimation model and temperature data derived from a measured value acquired by the plurality of temperature sensors;
calculating an estimated inner and outer race temperature difference from the calculated estimated temperature rise value on the inner race side of the bearing and a temperature rise value of the outer race side of the bearing calculated based on the temperature data derived from the measured value acquired by the temperature sensor measuring a temperature of the outer race side of the bearing; and
activating or stopping the cooling apparatus when the estimated inner and outer race temperature difference exceeds or falls below a predetermined threshold based on the selected estimation model.

10. The bearing cooling apparatus control method for the machine tool according to claim 9, wherein
the bearing cooling apparatus control method determines the cooling state of the bearing as any one of at least four states including a temperature fall transient state from an activation of the cooling apparatus until the delay time elapses, a temperature rise transient state from a stoppage of the cooling apparatus until the delay time elapses, a cooling steady state after the delay time elapsed from the activation of the cooling apparatus, and a heating steady state after the delay time elapsed from the stoppage of the cooling apparatus.

11. The bearing cooling apparatus control method for the machine tool according to claim 9, wherein
the delay time is calculated from a rotation speed of the rotation shaft using a predetermined function.

12. The bearing cooling apparatus control method for the machine tool according to claim 9, wherein
the delay time is a time until an amount of change per time becomes larger than a predetermined threshold value, the amount of change per time being calculated for at least one of the temperature data, the estimated temperature rise value of the inner race side of the bearing, and the estimated inner and outer race temperature difference.

13. A machine tool comprising:
a cooling apparatus configured to cool a specific portion that generates heat due to operation of the machine tool;
a plurality of sensors disposed at freely-selected positions including at least a position where a machine body temperature is measurable and a position where a temperature of the specific portion is measurable and
a device configured to:
determine a cooling state of the specific portion by determining whether the cooling apparatus is in an operating state or a stopped state and by determining whether a time measured from a base point of an activation or a stoppage of the cooling apparatus has elapsed a predetermined delay time or not;
select an estimation model corresponding to the determined cooling state of the specific portion from a plurality of estimation models prepared in advance corresponding to different cooling states of the specific portion; and
calculate an estimated temperature rise value of the specific portion based on the selected estimation model and temperature data derived from a measured value acquired by the plurality of temperature sensors.

14. The machine tool according to claim 13, wherein
the machine tool determines the cooling state of the specific portion as any one of at least four states including a temperature fall transient state from an activation of the cooling apparatus until the delay time elapses, a temperature rise transient state from a stoppage of the cooling apparatus until the delay time elapses, a cooling steady state after the delay time elapsed from the activation of the cooling apparatus, and a heating steady state after the delay time elapsed from the stoppage of the cooling apparatus.
